(19) United States
(12) Patent Application Publication
(10) Pub. No.: US 2026/0214665 A1
(43) Pub. Date: Jul. 23, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Ting FU, Beijing (CN)

(21) Appl. No.: 19/136,528

(22) PCT Filed: Dec. 7, 2022
(86) PCT No.: PCT/CN2022/137354

§ 371 Date: Jun. 6, 2025

(51) Int. Cl. H04W 72/1263; H04W 72/21

(52) U.S. Cl. CPC H04W 72/1263; H04W 72/21

(57) ABSTRACT

An information processing method is performed by a user equipment (UE) and includes: sending, on a scheduling request (SR) resource, SR information associated with a plurality of SR configurations, wherein the SR information indicates whether the UE has generated an SR associated with the SR configurations.

### CROSS-REFERENCE TO RELATED APPLICATION

The present application is a U.S. National Stage of International Application No. PCT/CN2022/137354, filed on Dec. 7, 2022, the content of which is incorporated herein by reference in its entirety.

### TECHNICAL FIELD

The present disclosure relates to the field of wireless communication technologies, and in particular to information processing methods and apparatuses, communication devices and storage media.

### BACKGROUND

User Equipment (UE) can use a Scheduling Request (SR) to request uplink transmission resources from a network device. The UE may also be named as a terminal.

For example, a network device, such as a base station, pre-configures SR resources through higher layer signaling, and provides the UE with an SR resource configuration and an SR configuration. The SR resource configuration is used to indicate resources for the UE to transmit an SR, and the SR configuration is associated with logical channels that the UE uses for uplink transmission. Specifically, the network device configures a plurality of SR resources for the UE. When the UE has data to transmit, it selects to send an SR on one SR resource to indicate that the UE wants to use a logical channel associated with the SR configuration for uplink data transmission. Typically, the base station monitors and performs blind detection on each SR resource, so as to know transmission requirements of the UE.

### SUMMARY

A first aspect of an embodiment of the present disclosure provides an information processing method, which is performed by a UE, and the method includes:
sending, on an SR resource, SR information associated with a plurality of SR configurations, where the SR information indicates whether the UE has generated an SR associated with the SR configurations.

A second aspect of an embodiment of the present disclosure provides an information processing method, which is performed by a base station, and the method includes:
receiving, on an SR resource, SR information associated with a plurality of SR configurations, where the SR information indicates whether a user equipment (UE) has generated an SR associated with the SR configurations.

A third aspect of an embodiment of the present disclosure provides an information processing apparatus, including:
a sending module, configured to send, on an SR resource, SR information associated with a plurality of SR configurations, where the SR information indicates whether a UE has generated an SR associated with the SR configurations.

A fourth aspect of an embodiment of the present disclosure provides an information processing apparatus, including:
a receiving module, configured to receive, on an SR resource, SR information associated with a plurality of SR configurations, where the SR information indicates whether a UE has generated an SR associated with the SR configurations.

A fifth aspect of an embodiment of the present disclosure provides a communication device, including a processor, a transceiver, a memory and an executable program stored on the memory and capable of being run by the processor, where the processor executes the information processing method provided in the first aspect and/or the second aspect when running the executable program.

A sixth aspect of an embodiment of the present disclosure provides a computer storage medium storing an executable program, the executable program, when executed by a processor, being capable of realizing the information processing method provided in the first aspect and/or the second aspect.

According to the technical solution provided by the embodiment of the present disclosure, SR information sent on one SR resource is related to multiple SR configurations. Compared to sending SR information associated with only one SR configuration on one SR resource, SR information can be sent using fewer SR resources than the number of SR configurations, thereby reducing the number of times the UE sends SR information. Consequently, the base station can monitor and blindly detect SR information on SR resources that are fewer in number than the SR configurations, thereby shortening a duration for which the base station maintains an active state while monitoring and blindly detecting SR information, increasing a dormant duration of the base station, reducing power consumption of both the UE and the base station, and extending a standby duration of the UE. Meanwhile, since one SR resource can be used for transmitting SR information associated with multiple SR configurations, compared to each SR configuration having a separate set of SR resource configurations, the number of SR resource configurations can be reduced, and the overhead of SR resources can be decreased.

It should be understood that the above general description and the following detailed descriptions are exemplary and explanatory only and do not limit the embodiments of the present disclosure.

### BRIEF DESCRIPTION OF DRAWINGS

FIG. 1 is a schematic structural diagram of a wireless communication system according to an embodiment of the present disclosure.

FIG. 2A is a flowchart of an information processing method according to an embodiment of the present disclosure.

FIG. 2B is a flowchart of an information processing method according to an embodiment of the present disclosure.

FIG. 2C is a flowchart of an information processing method according to an embodiment of the present disclosure.

FIG. 2D is a flowchart of an information processing method according to an embodiment of the present disclosure.

FIG. 2E is a flowchart of an information processing method according to an embodiment of the present disclosure.

FIG. 3A is a flowchart of an information processing method according to an embodiment of the present disclosure.

FIG. 3B is a flowchart of an information processing method according to an embodiment of the present disclosure.

FIG. 3C is a flowchart of an information processing method according to an embodiment of the present disclosure.

FIG. 3D is a flowchart of an information processing method according to an embodiment of the present disclosure.

FIG. 4 is a flowchart of an information processing apparatus according to an embodiment of the present disclosure.

FIG. 5 is a flowchart of an information processing apparatus according to an embodiment of the present disclosure.

FIG. 6 is a schematic structural diagram of a UE according to an embodiment of the present disclosure.

FIG. 7 is a schematic structural diagram of a network device according to an embodiment of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the embodiments of the present disclosure. Rather, they are merely examples of apparatuses and methods consistent with some aspects of embodiments of the present disclosure.

Terms used in embodiments of the present disclosure are only for a purpose of describing specific embodiments, and are not limiting the embodiments of the present disclosure. As used in the present disclosure, singular forms of “a” and “the” are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “if” as used herein can be interpreted as “at” or “when” or “in response to determining”.

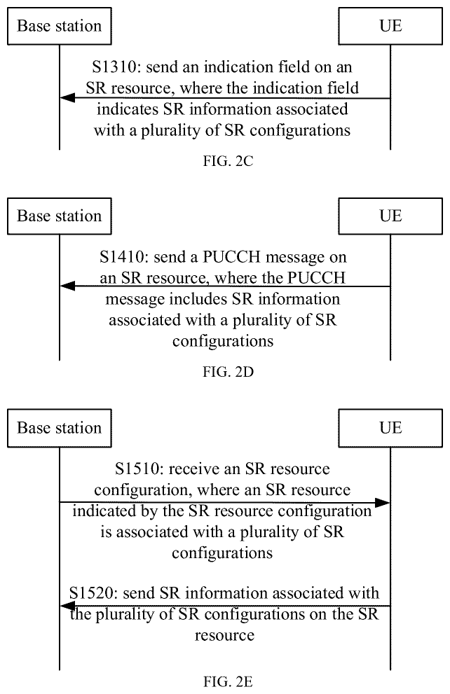

Please refer to FIG. 2, which shows a schematic structural diagram of a wireless communication system according to an embodiment of the present disclosure. As shown in the figure, the wireless communication system is a communication system based on cellular mobile communication technology, which may include a plurality of UEs 11 and a plurality of network devices 12.

A UE 11 may be a device that provides voice and/or data connectivity to users. The UE 11 can communicate with one or more core networks via a radio access network (RAN). The UE 11 can be an Internet of Things terminal, such as a sensor device, a mobile phone (or a “cellular” phone) and a computer with an Internet of Things terminal. For example, it can be a fixed, portable, pocket-sized, handheld, computer-built or vehicle-mounted device. For example, a station (STA), a subscriber unit, a subscriber station, a mobile station, a mobile, a remote station, an access point, a remote terminal, an access terminal, a user terminal, a user agent, a user device, or a user equipment. Or, the UE 11 can also be a device for an unmanned aerial vehicle. Or, the UE 11 can also be a vehicle-mounted device, for example, a driving computer with wireless communication function or an external onboard computer wireless communication device. Or, the UE 11 can also be a roadside device, such as a street lamp, a signal lamp or other roadside device with wireless communication function.

The network device 12 may be a network-side device in a wireless communication system. The wireless communication system can be the 4th generation mobile communication (4G) system, also known as long term evolution (LTE) system. Or, the wireless communication system can also be a 5G system, also known as a new radio (NR) system or a 5G NR system. Or, the wireless communication system can also be a further next-generation system of a 5G system. An access network in the 5G system can be named as a new generation-radio access network (NG-RAN). Or, an MTC system.

The network device 12 may be, for example, an evolved access device (eNB) adopted in the 4G system. Or, the network device 12 can also be an access device (gNB) adopting a centralized and distributed architecture in the 5G system. When the network device 12 adopts a centralized and distributed architecture, it usually includes a central unit (CU) and at least two distributed units (DUs). The centralized unit is provided with a protocol stack of a packet data convergence protocol (PDCP) layer, a radio link Control Protocol (RLC) layer and a media access control (MAC) layer, a distributed unit is provided with a protocol stack of a physical (PHY) layer, and the embodiments of the present disclosure do not limit specific implementations of the network device 12.

A wireless connection can be established between the network device 12 and the UE 11 through a wireless air interface. In different implementations, the wireless radio is a wireless radio based on the fourth generation mobile communication network technology (4G) standard; or the wireless radio is a wireless radio based on the fifth generation mobile communication network technology (5G) standard, for example, the wireless radio is a new radio; or, the wireless radio can also be a wireless radio based on a more next generation mobile communication network technology standard based on 5G.

The following provides explanations for relevant terms in the embodiments of the present disclosure, as detailed below.

SR resource: refers to a transmission resource used by a UE to send an SR or SR information.

SR: used in related technologies for the UE to request a base station or other network devices to schedule uplink transmission resources for the UE. Uplink transmission resource: used for a transmission of uplink data and/or uplink commands by the UE.

SR information: used in the embodiments of the present disclosure for the UE to request the base station or other network devices to schedule uplink transmission resources for the UE. Uplink transmission resource: used for a transmission of uplink data and/or uplink commands by the UE.

SR configuration: associated with a logical channel, and the logical channel is used for an uplink transmission of the UE.

SR resource configuration: at least used to indicate the SR resource(s).

As shown in FIG. 2A, an embodiment of present disclosure provides an information processing method, which is performed by a UE, and the method includes:

at S1110: sending SR information associated with a plurality of SR configurations on an SR resource, where the SR information indicates whether the UE has generated an SR associated with the SR configurations.

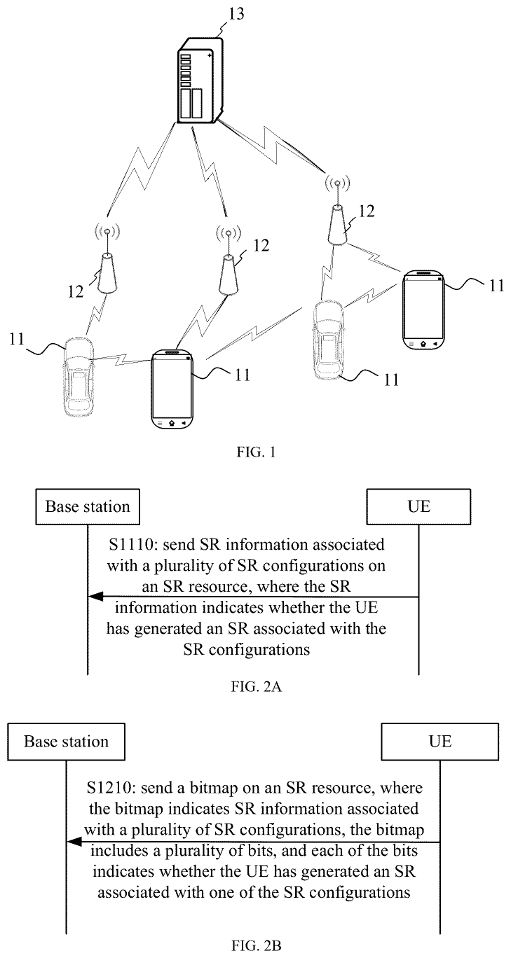

The UE may be the UE 11 shown in FIG. 1, specifically, the UE may include a fixed terminal and/or a mobile terminal. Mobile terminals may include: cell phones, tablets, smart home devices, smart office devices, in-vehicle devices, and/or wearable devices.

In an embodiment, the SR resource may be a time-frequency resource for transmitting SR information.

In an embodiment, sending SR information associated with a plurality of SR configurations on an SR resource may include at least one of the following:
sending multiple pieces of SR information on the SR resource, each piece of the SR information is used to indicate whether an SR configuration has an SR; or
sending a piece of SR information on the SR resource, the piece of SR information is used to indicate whether the plurality of SR configurations have SRs. In this way, the UE can send SR information for all SR configurations on fewer SR resources than the number of SR configurations, i.e., a network device, such as a base station, can receive SR information for all SR configurations on fewer SR resources than the number of SR configurations.

In some embodiments, S1110 may be understood as: one SR resource may be used for sending SR information for different SR configurations, rather than one SR resource being used for sending SR information for a specific SR configuration.

For example, the UE has M SR configurations, and SR information for these M SR configurations can be sent on one SR resource. Or, the M SR configurations can be divided into L SR configuration groups, where L is less than M, and both L and M are integers greater than 0. In other words, at least one SR configuration group includes two or more SR configurations. SR information associated with one SR configuration group is sent on one SR resource.

In some embodiments, the SR information sent on the SR resource occupies at least two bits and is related to the plurality of SR configurations. An SR configuration can be associated with a logical channel configuration. When the UE needs to send data on a certain logical channel, it can send SR information on an SR resource corresponding to (i.e., associated with) an SR configuration associated with the logical channel. After the base station receives the SR information on the SR resource, it can allocate an uplink transmission resource for the UE according to the logical channel associated with the SR configuration.

The difference between the SR information in the embodiment of the present disclosure and the SR in related technologies is reflected in any of the following aspects.

In related technologies, one SR is associated with one SR configuration; in the embodiments of the present disclosure, one SR information is associated with multiple SR configurations.

In related technologies, one SR typically includes one bit; in the embodiments of the present disclosure, one SR information includes at least two bits.

In related technologies, the number of SR resources for sending SRs is equal to the number of SR configurations; in the embodiments of the present disclosure, the number of SR resources for sending SR information is fewer than the number of SR configurations. In other words, in related technologies, the UE sends SR information for all SR configurations through the SR resources less than the SR configurations. In the embodiment of the present disclosure, a network device such as a base station receives the SR information on the SR resources less than the number of SR configurations, and according to this SR information, it is known whether the UE has generated the SR information associated with each SR configuration.

In related technologies, the UE sends an SR through a Physical Uplink Control Channel (PUCCH) message in format 0 or format 1; in the embodiments of the present disclosure, the UE sends SR information through a PUCCH message in format 0, format 1, format 2, format 3, or format 4. The above-mentioned multiple formats of PUCCH messages can be referred to in related technologies and are not elaborated on here.

In related technologies, each SR resource for sending an SR is associated with one SR configuration; in the embodiments of the present disclosure, one SR resource for sending SR information is associated with at least two SR configurations, i.e., the number of SR configurations associated with the used SR resource is greater than 1, and the number of SR configurations associated with different SR resource configurations can be different or the same.

It is worth noting that the above are examples of differences between SR information and SR, and specific implementations are not limited to these examples. The SR configuration includes a logical channel configuration, which indicates a logical channel for data transmission. In an example, the logical channel configuration includes, but is not limited to, a logical channel identifier.

After the UE sends SR information, the base station will receive the SR information and perform resource scheduling based on the SR information. The UE can then perform uplink transmission on the scheduled uplink resource. If the UE sends SR information indicating that it has generated an SR associated with SR configuration A and SR configuration B, after receiving the SR information, the base station will consider that the UE has sent the SR associated with SR configuration A and SR configuration B. Therefore, the base station will schedule an uplink resource according to a logical channel mapped by SR configuration A and SR configuration B. The uplink resource is used to meet an SR of the UE associated with SR configuration A and/or an SR of the UE associated with SR configuration B.

The uplink transmission includes but is not limited to uplink signaling and/or uplink data.

The SR information can be carried in a PUCCH message sent on a PUCCH to the base station. A format of the PUCCH message can be a message format including multiple bits as defined in related technologies or a newly defined dedicated format for sending the SR information.

In the embodiment of the present disclosure, SR information sent on one SR resource is related to multiple SR configurations. Compared to sending SR information associated with only one SR configuration on one SR resource, SR information can be sent using fewer SR resources than the number of SR configurations, thereby reducing the number of times the UE sends SR information. Consequently, the base station can monitor and blindly detect SR information on SR resources that are fewer in number than the SR configurations, thereby shortening a duration for which the base station maintains an active state while monitoring and blindly detecting SR information, increasing a dormant duration of the base station, reducing power consumption of both the UE and the base station, and extending a standby duration of the UE. Meanwhile, since one SR resource can be used for transmitting SR information associated with multiple SR configurations, compared to each SR configuration having a separate set of SR resource configurations, the number of SR resource configurations can be reduced, and the overhead of SR resources can be decreased.

As shown in FIG. 2B, an embodiment of present disclosure provides an information processing method, which is performed by a UE, and the method includes:

at S1210: sending a bitmap on an SR resource, where the bitmap indicates SR information associated with a plurality of SR configurations. The bitmap includes a plurality of bits, and each of the bits indicates whether the UE has generated an SR associated with one of the SR configurations. Different bits in the bitmap are associated with different SR configurations.

In some embodiments of the present disclosure, the SR information is carried by a bitmap. The number of bits included in the bitmap may be equal to the number of SR configurations associated with the SR information transmitted on one SR resource.

For example, the SR information sent on one SR resource is related to 8 SR configurations, then the bitmap may have 8 bits. For another example, the SR information sent on one SR resource is related to four SR configurations, then the bitmap may have four bits. In a word, in the embodiment of the present disclosure, since a bit in the bitmap sent on the SR resource is used for indicating whether the SR configuration has an SR, the bitmap is at least two bits.

In some embodiments, serial numbers of the corresponding SR configurations in the bitmap are sequentially sorted in the bitmap. For example, if there are M SR configurations, numbered 0 to M−1 respectively, the high bits to the lowest bits in the bitmap respectively correspond to the SR configurations numbered from 0 to M−1; or, the lowest bit to the highest bit in the bitmap respectively correspond to the SR configurations numbered from 0 to M−1.

In an embodiment, the bitmap is directly coded and modulated. For example, the bitmap can be coded and modulated according to a constellation diagram to obtain physical layer data sent to a network device such as a base station.

In another embodiment, the bitmap has a correspondence relationship with a first-type sequence, and different bit values of the bitmap correspond to different cyclic shifts and/or sequence types of the first-type sequence.

The first-type sequence may be a physical layer sequence. For example, the first-type sequence may be one or more sequences with high autocorrelation and low cross-correlation.

For example, the first-type sequence may be an M sequence, a Gold sequence, a Zadoff Chu (ZC) sequence, and/or a Pseudo-Noise Code (PN) sequence. The M sequence, gold sequence and ZC sequence here are different types of the first-type sequences.

One type of the first-type sequence has multiple cyclic shifts, and different cyclic shifts can correspond to different bit values of the bitmap. For example, suppose that a bitmap consists of 4 bits and has 16 values from “0000” to “1111” respectively. These 16 values can be mapped to different cyclic shifts of the same first-type sequence, or “0000” to “1000” can be mapped to one type of first-type sequence, and “1001” to “1111” can be mapped to be mapped to another type of first-type sequence. Or, each bit value of a bit sequence can be mapped to a different type of first-type sequence. In this way, the UE transmits the SR information based on the first-type sequence mapped from the bitmap. After receiving the first-type sequence, the network device such as the base station can obtain types and/or cyclic shifts of the first-type sequence through decoding, and then know the bitmap corresponding to the SR information sent by the UE, and then, by combining the correlation between the bitmap and SR configurations, the network device can identify which specific SR associated with the SR configurations have been generated by the UE.

In the embodiment of the present disclosure, after mapping the bitmap to the first-type sequence, the first-type sequence is directly sent. Subsequently, the network device such as the base station can directly perform coherent demodulation based on a correlator of the first-type sequence, which simplifies the demodulation operations of the network device.

A correspondence relationship between the cyclic shifts and/or sequence types of the first-type sequence and the bitmap is pre-known to both the UE and network device such as the base station. For example, the correspondence relationship may be agreed upon in a communication protocol or informed in advance by the network device such as the base station to the UE via higher layer signaling, etc.

As shown in FIG. 2C, an embodiment of present disclosure provides an information processing method, which is performed by a UE, and the method includes:

at S1310: sending an indication field on an SR resource, where the indication field indicates SR information associated with a plurality of SR configurations, the indication field includes: ┌log₂ N┐ bits, and the Ny is the number of SR configurations.

In some embodiments of the present disclosure, an indication field is sent on an SR resource, and the indication field may include at least two bits. These two bits are capable of indicating SR information associated with at least two SR configurations.

For example, N can take any value from 1 to 8. In some other embodiments, N can also be greater than 8.

┌log₂ N┐ denotes rounding up of log₂ N. For example, when N equals to 3 or 4, the indication field includes 2 bits. For another example, when N takes values between 5 and 8, the indication field includes 3 bits.

In the embodiment of the present disclosure, by using an indication field including ┌log₂ N┐ bits, it can be indicated that the UE has generated an SR associated with a plurality of SR configurations, thereby further saving signaling overhead between the UE and the base station.

In some embodiments, if the indication field includes ┌log₂ N┐ bits, there are 2^{┌log}^{₂} ^{N┐} binary bit sequences corresponding to these ┌log₂ N┐ bits. Any one of these 2^{┌log}^{₂} ^{N┐} binary bit sequences is associated with whether the UE has generated SR on each SR configuration. For example, assuming that N equals to 3 and ┌log₂ N┐ equals to 2, then the indication field has 2 bits and the 2 bits have a sequence of 4 bits “00”, “01”, “10” and “11”. The states of SRs associated with these 4 bit sequences and 3 SR configurations (SR configuration 1, SR configuration 2, and SR configuration 3, respectively) can be as shown in Table 1 below:

TABLE 1

| | Whether UE has | Whether UE has | Whether UE has |
|---|---|---|---|
| Bit | generated an SR | generated an SR | generated an SR |
| se- | associated with SR | associated with SR | associated with SR |
| quence | configuration 1 | configuration 2 | configuration 3 |
| 00 | No | No | No |
| 01 | Yes | No | No |
| 10 | No | Yes | No |
| 11 | No | No | Yes |

It is worth noting that in the example in Table 1 above, “00” means that the UE has not generated an SR associated with SR Configuration 1, SR Configuration 2 and SR Configuration 3.

In the actual implementation process, if the UE does not generate an SR on any SR configuration, the SR information need not be sent. Therefore, the all-zero bit sequence “00” can be configured to indicate that the UE has generated an SR associated with at least two SR configurations, with the specific two SR configurations being indicated through higher layer signaling or through SR information of the next SR resource. Of course, this is just an example, and the specific implementation is not limited to this.

In another embodiment, a bit sequence of ┌log₂ N┐ bits in the indication field indicates that the UE has generated an SR associated with a m-th SR configuration, where the m-th SR configuration is an SR configuration with a highest mapped logical channel priority among X SR configurations, the X SR configurations are SR configurations associated with the SR generated by the UE, the m is a natural number less than the y, and the X is a natural number less than the N.

In this embodiment, a bit sequence of the indication field is mapped to only one SR configuration, indicating the SR configuration with the highest logical channel priority among the SR configurations associated with the SR generated by the UE.

At a moment, UE generates an SR associated with multiple SR configurations, but an indication field of an SR resource in this period can only carry a bit sequence at a time. The SRs associated with different SR configurations can be indicated by SR information sent on SR resources in different periods.

For example, there are 4 SR configurations, and the indication field is 2 bits; The bit sequence composed of these two bits can include “00”, “01”, “10” and “11”, which respectively indicate that the UE has generated an SR associated with a certain SR configuration at one time. If the UE generates SRs in both the second SR configuration and the third SR configuration in the current period of SR resource, at this time, the logical channel priorities mapped by the second SR configuration and the third SR configuration are compared. If the logical channel priorities of multiple SR configurations are different, the SR of the SR configuration with the highest logical channel priority is preferentially sent on the SR resource in this period according to the logical channel priorities from high to low. If the logical channel priorities mapped by multiple SR configurations associated with the SR are the same, an SR configuration can be randomly selected as the SR configuration associated with the indication field sent on the SR resource in this period, or the SR configuration associated with the indication field sent on the SR resource in this period can be selected according to an SR Identifier (ID) of the SR configuration. The SR IDs of the SR configuration can be the serial numbers of multiple SR configurations.

It is worth noting that, in the embodiment of the present disclosure, the correlation between the SR information transmitted on an SR resource and multiple SR configurations is reflected in selecting the SR configuration with the highest logical channel priority when multiple SR configurations have SRs.

If only one SR configuration has an SR in this period, the indication field will determine a value carried by an indication bit according to the SR configuration associated with the SR.

In an embodiment, the indication field can be directly encoded by various modulation methods. For example, a constellation diagram can be used to encode each bit in the indication field.

In another embodiment, the indication field has a correspondence relationship with a second-type sequence, and different bit sequences of the indication field correspond to different cyclic shifts and/or sequence types of the second-type sequence.

It is worth noting that the second-type sequence here is independent of the aforementioned first-type sequence and can be the same as or different from the first-type sequence. Similarly, the second-type sequence is a physical layer sequence.

The second-type sequence may be an M sequence, a Gold sequence, a Zadoff Chu (ZC) sequence, and/or a Pseudo-Noise Code (PN) sequence. The M sequence, gold sequence and ZC sequence here are different types of the second-type sequences.

In the embodiment of the present disclosure, after mapping the bitmap to the second-type sequence, the second-type sequence is directly sent. Subsequently, the network device such as the base station can directly perform coherent demodulation based on a correlator of the second-type sequence, which simplifies the demodulation operations of the network device.

A correspondence relationship between the cyclic shifts and/or sequence types of the third-type sequence and the SR information is pre-known to both the UE and network device such as the base station. For example, the correspondence relationship may be agreed upon in a communication protocol or informed in advance by the network device such as the base station to the UE via higher layer signaling, etc.

An embodiment of the present disclosure provides an information processing method, which is performed by a user equipment (UE), and the method includes:
sending SR information associated with a plurality of SR configurations on an SR resource, where the SR information indicates whether the UE has generated an SR associated with the SR configurations, the SR information is carried by a third-type sequence, in which, different kinds of the SR information correspond to different cyclic shifts and/or sequence types of the third-type sequence.

The third-type sequence here is a physical layer sequence. The SR information has a correspondence relationship directly with the third-type sequence, so the third-type sequence can be directly determined based on the information content of the SR information.

Similarly, the third-type sequence may be one or more types of physical layer sequences with good autocorrelation and low cross-correlation, such as an M sequence, a Gold sequence, a Zadoff Chu (ZC) sequence, and/or a Pseudo-Noise Code (PN) sequence.

In this way, the network device such as the base station receives the third-type sequence and is aware of the SR information sent by the UE through the correspondence relationship between the third-type sequence and the SR information. It is worth noting that the correspondence relationship between the cyclic shifts and/or sequence types of the third-type sequence and the SR information is pre-known to both the UE and network device such as the base station. For example, the correspondence relationship may be agreed upon in a communication protocol or informed in advance by the network device such as the base station to the UE via higher layer signaling, etc.

As shown in FIG. 2D, an embodiment of present disclosure provides an information processing method, which is performed by a UE, and the method includes:
at S1410: sending a physical uplink control channel (PUCCH) message on an SR resource, where the PUCCH message includes SR information associated with a plurality of SR configurations.

If the SR information is carried in the PUCCH message, it indicates that the SR information is sent via PUCCH. The base station will monitor and receive the SR information on the PUCCH.

A format of the PUCCH message can be of various types. For example, the format of the PUCCH message includes format 0, format 1, format 2, format 3 or format 4.

It is worth noting that the format of the PUCCH message may not be any one of the related technologies, but may be a message format specially designed for sending the SR information.

In the embodiment of the present disclosure, the number of PUCCH messages can correspond to formats such as 0/1/2/3/4, etc.

If the format of the PUCCH message transmitting the SR information is predefined by a protocol, no information exchange is required between the base station and the UE, which is determined by the UE and the base station, respectively, according to the protocol.

If the format of the PUCCH message transmitting the SR information is indicated by the SR configuration or SR resource configuration, it needs to be configured by the base station through higher layer signaling at a Radio Resource Control (RRC) layer and/or a Media Access Control (MAC) layer.

If the PUCCH message format is predefined by the protocol, it represents a static configuration. If it is indicated by the base station through the SR configuration or SR resource configuration, it is equivalent to a semi-static configuration of the PUCCH message format.

For example, in this dynamic configuration scenario, the format of the PUCCH message is determined according to the number of SR configurations associated with an SR resource. For example, if the SR information is carried by a bitmap or an indication bit, a minimum number of bits required is determined according to the number of SR configurations associated with the SR resource. If the required number of bits is less than or equal to 2, format 0 or 1 can be selected; and if the required number of bits is greater than 2, format 2/3/4 can be selected. The number of SR configurations associated with an SR resource can be understood as the number of SR configurations involved in the SR information sent on the SR resource.

The SR information indicated by the SR configuration sends related SR parameters, the SR parameters may include, but are not limited to, the maximum number of transmissions and a duration of a prohibition timer.

Resource parameters indicated by the SR resource configuration include, but are not limited to, a periodicity and/or offset of the SR resource.

In the embodiment of the present disclosure, the SR resources may be semi-statically configured with corresponding semi-static periods. If a set of SR resource configurations is reset, the semi-static periodicities of the SR resources associated with the SR resource configurations may also change.

In summary, in the embodiment of the present disclosure, the format of the PUCCH message carrying SR information can be any of the aforementioned formats 0, 1, 2, 3, or 4. During specific implementation, the format of the PUCCH message can also be any extended format of subsequent PUCCH messages, as long as the corresponding number of PUCCH messages can carry the information associated with multiple SR configurations.

It is worth noting that the information processing method provided by the embodiments of the present disclosure can be implemented independently or in combination with any of the aforementioned embodiments, for example, in combination with the methods shown in FIG. 2A, FIG. 2B and/or FIG. 2C. For example, the SR information, the bitmap, or the indication field in FIG. 2A, FIG. 2B, and/or FIG. 2C may all be carried in the PUCCH message and sent to the base station.

As shown in FIG. 2E, an embodiment of present disclosure provides an information processing method, which is performed by a UE, and the method includes:
at S1510: receiving an SR resource configuration, where an SR resource indicated by the SR resource configuration is associated with a plurality of SR configurations; and
at S1520: sending SR information associated with the plurality of SR configurations on the SR resource, where the SR information indicates whether the UE has generated an SR associated with the SR configurations.

For example, each SR resource configured by the SR resource configuration can be used for sending SR information associated with at least two SR configurations.

For example, the current SR configuration has SR configuration 0 to SR configuration 7. The SR resource configuration is configured with two SR resources, namely SR resource 0 and SR resource 1. SR resource 0 is associated with SR configuration 0 to SR configuration 3, and SR resource 1 is associated with SR configuration 4 to SR configuration 7. In this way, when the UE has generated an SR associated with any of the SR configurations 0 to SR configuration 3, SR information is sent on the SR resource 0. If the UE has generated an SR associated with any of the SR configurations 0 to SR configuration 3, it requests a message on SR configuration 1.

In this way, in a semi-static period of SR transmission, the UE only needs to send SR information on two SR resources instead of eight SR resources, and the base station only needs to monitor and blindly detect SR information on two SR resources instead of blindly detecting and monitoring SR information on eight SR resources, thus saving power consumption of the UE and the base station respectively, reducing the number of SR resources and signaling overhead between the UE and the base station. The SR resource configuration may at least include a periodicity and/or offset of the SR resource.

In some embodiments, the SR configuration includes an SR identifier (scheduling Request Id), which may be used to distinguish different SR configurations.

In some embodiments, the SR resource configuration may at least include a periodicity and/or offset of the SR resource.

The SR resource configuration may include: an SR resource identifier (scheduling Request Resource Id), which may be used to distinguish different SR resources and/or SR resource configurations. An SR resource is associated with a plurality of SR configurations, then in the SR resource configurations, in some embodiments, an SR resource identifier will correspond to a plurality of SR identifiers. The plurality of SR identifiers respectively indicate a plurality of SR configurations associated with the SR resource corresponding to the SR resource identifier.

In some embodiments, according to the SR resource configuration, the SR resources that can be used for sending SR information can be determined.

It is worth noting that the SR resources in the embodiment of the present disclosure may be configured in a semi-static periodic manner.

It is worth noting that the information processing method provided by the embodiments of the present disclosure can be implemented independently or in combination with any of the aforementioned embodiments, for example, in combination with the methods shown in FIG. 2A, FIG. 2B, FIG. 2C and/or FIG. 2D.

In some embodiments, a plurality of SR configurations associated with SR information carried by an SR resource have an identical first parameter.

In some embodiments, second parameters of the plurality of SR configurations are different.

The first parameter is used for reporting the SR information of the SR configurations.

The second parameter is at least used to determine a logical channel corresponding to an SR configuration.

The first parameter can be named as a reporting parameter, while the second parameter may include a resource parameter and/or an SR ID, etc.

The resource parameters may include: an identifier of a logical channel used for uplink transmission.

Since a plurality of SR configurations have the identical first parameter, the plurality of SR configurations can be configured at one time, thus reducing the signaling overhead of SR configurations. It is worth noting that the logical channels mapped by the plurality of SR configurations associated with one SR resource are at least partially different. The plurality of SR configurations with the identical first parameter can also be separately configured by the base station using different signaling.

For example, the first parameter may include at least one of the following:
a parameter of a prohibition timer, used to start the prohibition timer, where reporting the SR information is prohibited during a running time of the prohibition timer; or
a maximum number of transmissions, used to indicate a maximum number of repeated transmissions of an SR for one of the SR configurations.

For example, SR parameters may include a parameter for a prohibition timer, which includes but is not limited to a duration parameter for the prohibition timer. The duration parameter for the prohibition timer can be an enumeration parameter. Within a timing range after the prohibition timer is started, it is the running time of the prohibition timer. During the running time of the prohibition timer, the reporting of the SR information will be prohibited, thereby reducing unnecessary reporting of SR information.

If the number of retransmissions of an SR for an SR configuration reaches the maximum number of transmissions and the scheduling still fails, it means that the uplink of the UE fails. In this case, the UE can solve the problem of uplink failure by reconnecting or accessing the base station again.

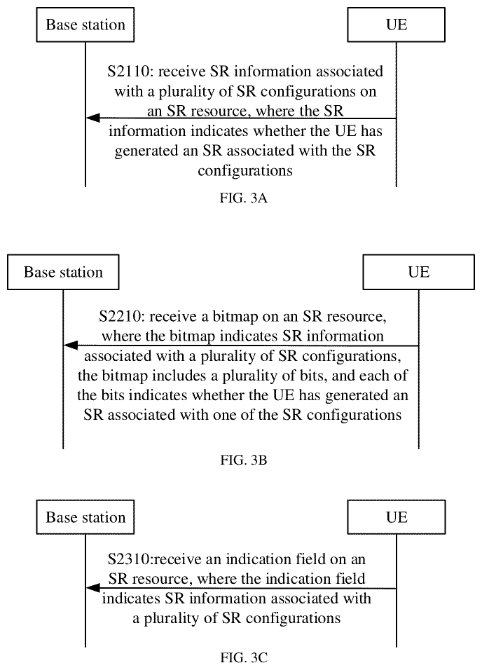

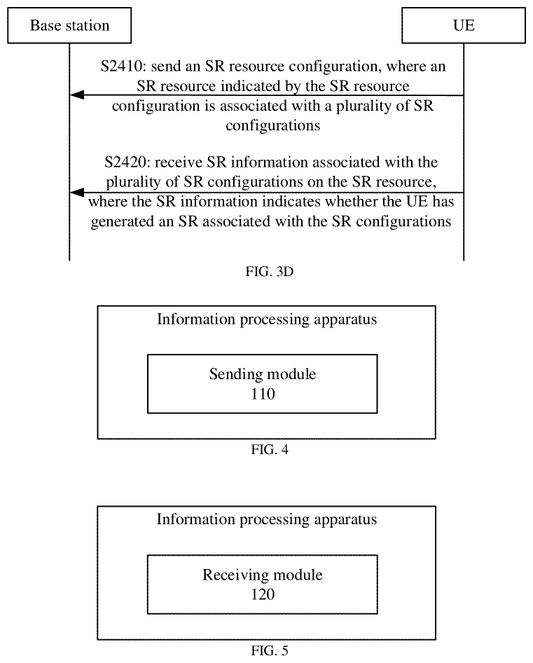

As shown in FIG. 3A, an embodiment of present disclosure provides an information processing method, which is performed by a base station, and the method includes:
at S2110: receiving SR information associated with a plurality of SR configurations on an SR resource, where the SR information indicates whether the UE has generated an SR associated with the SR configurations.

The base station may be an evolved base station (eNB) and/or a next generation base station (gNB).

In this embodiment, the SR information related (associated) to the plurality of SR configurations may be received on one SR resource. The SR information may indicate whether the UE has generated an SR associated with the corresponding SR configuration(s). If an SR configuration is associated with all SRs, it means that UE has a transmission requirement of uplink data on a logical channel corresponding to the SR configuration.

Since the SR information associated with the plurality of SR configurations can be received on one SR resource, the monitoring and blind detection of all SR information associated with SR configurations can be completed on SR resources less than the number of SR configurations, which can reduce the number of SR resources that the base station needs to monitor and blind detect, and reduce the number of SR resources occupied by transmitting SR information, thus saving the power consumption of the base station.

In an embodiment, sending SR information associated with a plurality of SR configurations on an SR resource may include at least one of the following:
sending multiple pieces of SR information on the SR resource; each piece of the SR information is used to indicate whether an SR configuration has an SR; or
sending a piece of SR information on the SR resource, the piece of SR information is used to indicate whether the plurality of SR configurations have SRs. In this way, the UE can send SR information for all SR configurations on fewer SR resources than the number of SR configurations, i.e., a network device, such as a base station, can receive SR information for all SR configurations on fewer SR resources than the number of SR configurations.

In some embodiments, S2110 may be understood as: one SR resource may be used for transmission of SR information for different SR configurations, rather than one SR resource being used for transmission of SR information for a specific SR configuration.

For example, the UE has M SR configurations, and SR information for these M SR configurations can be sent on one SR resource. Or, the M SR configurations can be divided into L SR configuration groups, where L is less than M, and both L and M are integers greater than 0. In other words, at least one SR configuration group includes two or more SR configurations. SR information associated with one SR configuration group is sent on one SR resource.

In some embodiments, the SR information sent on the SR resource occupies at least two bits and is related to the plurality of SR configurations. An SR configuration can be associated with a logical channel configuration. When the UE needs to send data on a certain logical channel, it can send SR information on an SR resource corresponding to (i.e., associated with) an SR configuration associated with the logical channel. After the base station receives the SR information on the SR resource, it can allocate an uplink transmission resource for the UE according to the logical channel associated with the SR configuration.

The SR configuration includes a logical channel configuration, which indicates a logical channel for data transmission. In an example, the logical channel configuration includes, but is not limited to, a logical channel identifier. After the UE sends SR information, the base station performs resource scheduling based on the SR information. The UE can then perform uplink transmission on the scheduled uplink resource. The uplink transmission includes but is not limited to uplink signaling and/or uplink data.

The SR information can be received in a Physical Uplink Control Channel (PUCCH) message sent on a PUCCH.

As shown in FIG. 3B, an embodiment of present disclosure provides an information processing method, which is performed by a base station, and the method includes:
at S2210: receiving a bitmap on an SR resource, where the bitmap indicates SR information associated with a plurality of SR configurations. The bitmap includes a plurality of bits, and each of the bits indicates whether the UE has generated an SR associated with one of the SR configurations. Different bits in the bitmap are associated with different SR configurations.

In some embodiments, serial numbers of the corresponding SR configurations in the bitmap are sequentially sorted in the bitmap. For example, if there are M SR configurations, numbered 0 to M−1 respectively, the high bits to the lowest bits in the bitmap respectively correspond to the SR configurations numbered from 0 to M−1; or, the lowest bit to the highest bit in the bitmap respectively correspond to the SR configurations numbered from 0 to M−1.

For example, after receiving the information sent by the UE, the received information is demodulated by a mutually agreed modulation and coding method with the UE, and the bitmap is obtained by means of constellation diagram mapping and the like.

For another example, the bitmap has a correspondence relationship with a first-type sequence, and different bit values of the bitmap correspond to different cyclic shifts and/or sequence types of the first-type sequence.

At this time, the base station can directly demodulate the first-type sequence using a correlator for the first sequence, thereby determining the sequence types and/or cyclic shifts of the first-type sequence transmitted by the UE. Based on the correspondence relationship, the base station obtains the bitmap and then determines, according to the bitmap, whether the UE has generated an SR associated with one or more SR configurations.

As shown in FIG. 3C, an embodiment of present disclosure provides an information processing method, which is performed by a base station, and the method includes:
at S2310: receiving an indication field on an SR resource, where the indication field indicates SR information associated with a plurality of SR configurations.

The indication field includes: ┌log₂ N┐ bits, and the N is the number of SR configurations.

In the embodiment of the present disclosure, an indication field is sent on an SR resource, and the indication field may include at least two bits. These two bits are capable of indicating SR information associated with at least two SR configurations.

For example, N can take any value from 1 to 8. In some other embodiments, N can also be greater than 8.

┌log₂ N┐ denotes rounding up of log₂ N. For example, due to the existence of rounding up, when N equals to 3 and 4, the indication fields both include 2 bits. For another example, when N takes values between 5 and 8, the indication bits have 3 bits.

In the embodiment of the present disclosure, by using an indication field including ┌log₂ N┐ bits, it can be indicated that a plurality of SR configurations have SRs, thereby further saving signaling overhead.

For example, N can take any value from 1 to 8. In some other embodiments, N can also be greater than 8.

┌log₂ N┐ denotes rounding up of log₂ N. For example, when N equals to 3 or 4, the indication field includes 2 bits. For another example, when N takes values between 5 and 8, the indication field includes 3 bits.

In the embodiment of the present disclosure, by using an indication field including ┌log₂ N┐ bits, it can be indicated that the UE has generated an SR associated with a plurality of SR configurations, thereby further saving signaling overhead between the UE and the base station.

In another embodiment, a bit sequence of ┌log₂ N┐ bits in the indication field indicates that the UE has generated an SR associated with a m-th SR configuration, where the m-th SR configuration is an SR configuration with a highest mapped logical channel priority among X SR configurations, the X SR configurations are SR configurations associated with the SR generated by the UE, the m is a natural number less than the, and the X is a natural number less than the.

In this embodiment, a bit sequence of the indication field is mapped to only one SR configuration, indicating the SR configuration with the highest logical channel priority among the SR configurations associated with the SR generated by the UE.

At a moment, UE generates an SR associated with multiple SR configurations, but an indication field of an SR resource in this period can only carry a bit sequence at a time. The SRs associated with different SR configurations can be indicated by SR information sent on SR resources in different periods.

It is worth noting that, in the embodiment of the present disclosure, the correlation between the SR information transmitted on an SR resource and multiple SR configurations is reflected in selecting the SR configuration with the highest logical channel priority when multiple SR configurations have SRs.

In an embodiment, the indication field can be directly encoded by various modulation methods. For example, a constellation diagram can be used to encode each bit in the indication field.

In another embodiment, the indication field has a correspondence relationship with a second-type sequence, and different bit sequences of the indication field correspond to different cyclic shifts and/or sequence types of the second-type sequence.

It is worth noting that the second-type sequence here is independent of the aforementioned first-type sequence and can be the same as or different from the first-type sequence. Similarly, the second-type sequence is a physical layer sequence.

The second-type sequence may be an M sequence, a Gold sequence, a Zadoff Chu (ZC) sequence, and/or a Pseudo-Noise Code (PN) sequence. The M sequence, gold sequence and ZC sequence here are different types of the second-type sequences.

In the embodiment of the present disclosure, after mapping the bitmap to the second-type sequence, the second-type sequence is directly sent. Subsequently, the network device such as the base station can directly perform coherent demodulation based on a correlator of the second-type sequence, which simplifies the demodulation operations of the network device.

A correspondence relationship between the cyclic shifts and/or sequence types of the third-type sequence and the SR information is pre-known to both the UE and network device such as the base station. For example, the correspondence relationship may be agreed upon in a communication protocol or informed in advance by the network device such as the base station to the UE via higher layer signaling, etc.

In some embodiments, the SR information is carried by a third-type sequence, in which, different kinds of the SR information correspond to different cyclic shifts and/or sequence types of the third-type sequence.

The third-type sequence here is a physical layer sequence. The SR information has a correspondence relationship directly with the third-type sequence, so the third-type sequence can be directly determined based on the information content of the SR information.

Similarly, the third-type sequence may be one or more types of physical layer sequences with good autocorrelation and low cross-correlation, such as an M sequence, a Gold sequence, a Zadoff Chu (ZC) sequence, and/or a Pseudo-Noise Code (PN) sequence.

In this way, the network device such as the base station receives the third-type sequence and is aware of the SR information sent by the UE through the correspondence relationship between the third-type sequence and the SR information. It is worth noting that the correspondence relationship between the cyclic shifts and/or sequence types of the third-type sequence and the SR information is pre-known to both the UE and network device such as the base station. For example, the correspondence relationship may be agreed upon in a communication protocol or informed in advance by the network device such as the base station to the UE via higher layer signaling, etc.

In some embodiments, a physical uplink control channel (PUCCH) message is received on an SR resource, where the PUCCH message includes the SR information associated with the plurality of SR configurations.

If the SR information is carried in the PUCCH message, it indicates that the SR information is sent via PUCCH. The base station will monitor and receive the SR information on the PUCCH.

A format of the PUCCH message can be of various types. For example, the format of the PUCCH message includes format 0, format 1, format 2, format 3 or format 4.

It is worth noting that the format of the PUCCH message may not be any one of the related technologies, but may be a message format specially designed for sending the SR information.

In the embodiment of the present disclosure, the SR information is carried in the PUCCH message, and the format of the PUCH message may be format 0, 1, 2, 3, or 4. That is, in the embodiment of the present disclosure, candidate formats of the PUCCH message carrying SR information include: formats 0, 1, 2, 3 and/or 4.

The format of the PUCCH message carrying SR information can be predefined by the protocol or can be signaled to the UE by the base station through SR configuration or SR resource configuration.

As shown in FIG. 3D, an embodiment of present disclosure provides an information processing method, which is performed by a base station, and the method includes:
at S2410: sending an SR resource configuration, where an SR resource indicated by the SR resource configuration is associated with a plurality of SR configurations; and
at S2420: receiving SR information associated with the plurality of SR configurations on the SR resource, where the SR information indicates whether the UE has generated an SR associated with the SR configurations.

The base station can configure the SR resource through higher layer signaling such as RRC signaling and/or MAC signaling, so as to obtain the SR resource configuration. Thus, the SR resource configuration obtained by the UE is carried in the higher layer signaling. This higher layer signaling includes, but is not limited to, RRC signaling and/or MAC layer signaling.

After the base station sends the SR resource configuration to the UE, it can receive the SR information associated with the plurality of SR configurations on one SR resource based on the SR resource configuration. On one hand, the number of SR resources can be reduced, and on the other hand, the information interaction between the UE and the base station can be reduced, thereby reducing resource overhead, signaling overhead and/or power consumption overhead.

The SR configuration includes an SR identifier (scheduling Request Id), which may be used to distinguish different SR configurations.

The SR resource configuration may at least include a periodicity and/or offset of the SR resource.

The SR resource configuration may include: an SR resource identifier (scheduling Request Resource Id), which may be used to distinguish different SR resources and/or SR resource configurations. An SR resource is associated with a plurality of SR configurations, then in the SR resource configurations, an SR resource identifier will correspond to a plurality of SR identifiers. The plurality of SR identifiers respectively indicate a plurality of SR configurations associated with the SR resource corresponding to the SR resource identifier.

According to the SR resource configuration, the SR resources that can be used for sending SR information can be determined.

In an embodiment, the periodicity and offset of the SR resource can be represented by a parameter: periodicity And Offset.

It is worth noting that the SR resources in the embodiment of the present disclosure may be configured in a semi-static periodic manner.

It is worth noting that the information processing method provided by the embodiments of the present disclosure can be implemented independently or in combination with any of the aforementioned embodiments, for example, in combination with the methods shown in FIG. 3A, FIG. 3B and/or FIG. 3C.

In the present disclosure, if a plurality of SR configurations are associated with one SR resource, the plurality of SR configurations may have the same SR parameter(s). The SR parameter may include a second parameter related to uplink transmission and/or a first parameter used for reporting SR information.

The first parameter can be named as a reporting parameter, while the second parameter may include a resource parameter and/or an SR ID, etc.

The resource parameters may include: an identifier of a logical channel used for uplink transmission.

Since a plurality of SR configurations have the identical first parameter, the plurality of SR configurations can be configured at one time, thus reducing the signaling overhead of SR configurations. It is worth noting that the logical channels mapped by the plurality of SR configurations associated with one SR resource are at least partially different.

For example, the first parameter may include at least one of the following:
a parameter of a prohibition timer, used to start the prohibition timer, where receiving the SR information is stopped during a running time of the prohibition timer; or
a maximum number of transmissions, used to indicate a maximum number of repeated transmissions of an SR for one of the SR configurations.

For example, SR parameters may include a parameter for a prohibition timer, which includes but is not limited to a duration parameter for the prohibition timer. The duration parameter for the prohibition timer can be an enumeration parameter. Within a timing range after the prohibition timer is started, it is the running time of the prohibition timer. During the running time of the prohibition timer, the UE is prohibited from reporting SR information, and thus the base station does not need to monitor and blindly detect SR information.

For example, the parameter of the prohibition timer can be indicated by a parameter (sr-ProhibitTimer) in the SR configuration.

If the number of retransmissions of an SR for an SR configuration reaches the maximum number of transmissions and the scheduling still fails, it means that the uplink of the UE fails. In this case, the UE can solve the problem of uplink failure by reconnecting or accessing the base station again.

As another example, the maximum number of transmissions may be indicated by a parameter (SR-transmax) in the SR configuration.

The SR information of multiple sets of SR configurations corresponds to one set of SR resources. This reduces the number of SR resources monitored by the base station, thus reducing energy consumption. At the same time, each SR time-frequency resource needs to carry multiple sets of SR information of SR configuration, so the SR information needs to include multi-bit information to indicate the SR information corresponding to the multiple sets of SR configurations.

For example, originally 8 sets of SR configurations correspond to 8 sets of SR resources (time-frequency resources for sending SR information), and the base station needs to perform periodic detection on all 8 sets of SR resources. In the embodiment of the present disclosure, these 8 sets of SR configurations may be combined into less than 8 pieces of SR information and sent to the base station.

For example, eight SR configurations are divided into two groups of SR configurations, and one SR configuration group includes four SR configurations. The codes of multiple SR configurations in the same SR configuration group are distributed continuously. Or, the serial numbers of multiple SR configurations in an SR configuration group are all even numbers or odd numbers.

In summary, if the eight SR configurations are grouped into two SR configuration groups, the SR information for multiple SR configurations within each group can be transmitted via two separate SR resources. Therefore, the base station only needs to perform periodic detection on two SR resources, reducing the detection opportunities for the base station and potentially increasing the sleep duration of the base station.

The SR resource configuration configured by the base station for the terminal corresponds to multiple sets of SR configurations. That is, one set of SR resources can be associated with N (N>1) sets of SR configurations. One set of SR resources may include multiple periodically distributed SR resources.

In an embodiment, the SR transmitted on the SR resource includes multi-bit SR information to indicate the SR information corresponding to N sets of SR configurations. For example, this can be achieved through a bitmap format, where the bitmap includes N bits. One bit corresponds to a set of SR configurations. If the set of SR configurations has a corresponding SR that needs to be transmitted, the corresponding bit is 1, otherwise it is 0.

In another embodiment, the SR information may also use an indication field of ┌log₂ N┐ bits to indicate index information of an SR configuration with an SR to be transmitted among N SR configurations. If multiple SR configurations need to transmit SRs, an index of one of them is selected for indication. For example, an index corresponding to an SR configuration with the highest logical channel priority can be indicated. If there are no SRs to be transmitted for any SR configuration, all bits are set to 0. The index information may be the serial number of the SR configuration.

In some embodiments, the SR information is sent on the SR resource using a PUCCH channel of PUCCH format 2/3/4.

As shown in FIG. 4, an embodiment present disclosure provides an information processing apparatus, including:

a sending module 110, configured to send SR information associated with a plurality of SR configurations on an SR resource, where SR information indicates whether a UE has generated an SR associated with the SR configurations.

The information processing apparatus may be included in a UE.

In some embodiments, the sending module 110 may be a program module, which can implement the above operations after being executed by a processor.

In another embodiments, the sending module 110 may be a hardware-software combination module, and the hardware-software combination module includes, but is not limited to, various programmable arrays, the programmable arrays include, but are not limited to, field programmable arrays and/or complex programmable arrays.

In still other embodiments, the sending module 110 may be a pure hardware module, and the pure hardware module includes, but is not limited to, an application specific integrated circuit.

In some embodiments, the information processing apparatus further includes: a storage module, and the storage module is configured to store the SR information.

In some embodiments, the sending module 110 is further configured to send a bitmap on the SR resource, where the bitmap indicates the SR information associated with the plurality of SR configurations, where a bit in the bitmap is used to indicate whether an SR configuration has an SR.

In some embodiments, the bitmap has a correspondence relationship with a first-type sequence, and different bit values of the bitmap correspond to different cyclic shifts and/or sequence types of the first-type sequence.

In some embodiments, the sending module 110 is further configured to send an indication field on the SR resource, where the indication field includes: ┌log₂ N┐ bits, and the N is the number of the SR configurations.

In some embodiments, a bit sequence of ┌log₂ N┐ bits in the indication field indicates whether the UE has generated an SR associated with one or more SR configurations among the N SR configurations; or, a bit sequence of ┌log₂ N┐ bits in the indication field indicates that the UE has generated an SR associated with a m-th SR configuration, where the m-th SR configuration is an SR configuration with a highest mapped logical channel priority among X SR configurations, the X SR configurations are SR configurations associated with the SR generated by the UE, the m is a natural number less than the y, and the X is a natural number less than the N.

In some embodiments, the indication field has a correspondence relationship with a second-type sequence, and different bit sequences of the indication field correspond to different cyclic shifts and/or sequence types of the second-type sequence.

In some embodiments, the sending module is further configured to send a physical uplink control channel (PUCCH) message on the SR resource, where the PUCCH message includes the SR information associated with the plurality of SR configurations.

In some embodiments, the SR information is carried by a third-type sequence, in which, different kinds of the SR information correspond to different cyclic shifts and/or sequence types of the third-type sequence.

A format of the PUCCH message includes: format 0, format 1, format 2, format 3 or format 4.

In some embodiments, the apparatus further includes:

a receiving module, configured to receive an SR resource configuration, where an SR resource indicated by the SR resource configuration is associated with a plurality of SR configurations.

In some embodiments, the plurality of SR configurations associated with the SR information carried by the SR resource have the identical first parameter and different second parameters, where the first parameter is used for reporting the SR information of the SR configurations, and the second parameter is at least used to determine a logical channel corresponding to an SR configuration.

In some embodiments, the first parameter includes at least one of:
a parameter of a prohibition timer, used to start the prohibition timer, where reporting the SR information is prohibited during a running time of the prohibition timer; or
a maximum number of transmissions, used to indicate a maximum number of repeated transmissions of an SR for one of the SR configurations.

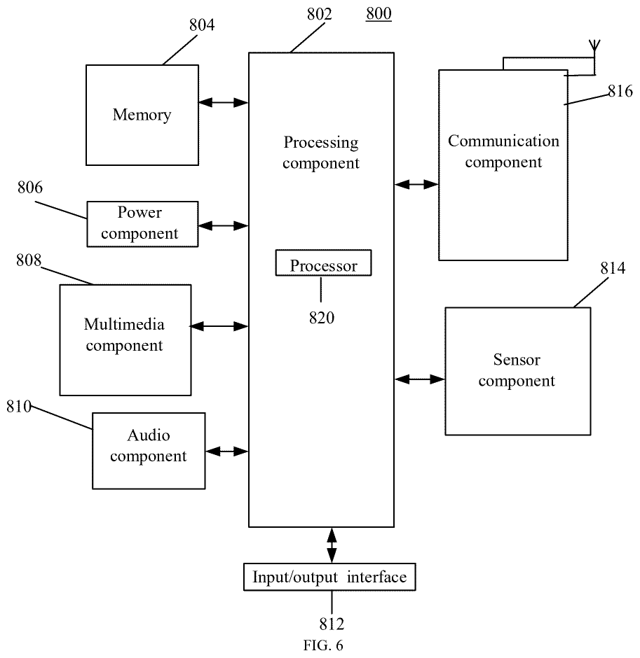

As shown in FIG. 5, an embodiment present disclosure provides an information processing apparatus, including:
a receiving module 210, configured to receive SR information associated with a plurality of SR configurations on an SR resource, where the SR information indicates whether a UE has generated an SR associated with the SR configurations.

The information processing apparatus may be included in a base station.

In some embodiments, the receiving module 210 may be a program module, which can implement the above operations after being executed by a processor.

In some embodiments, the receiving module 210 may be a hardware-software combination module, and the hardware-software combination module includes, but is not limited to, various programmable arrays, the programmable arrays include, but are not limited to, field programmable arrays and/or complex programmable arrays.

In still other embodiments, the receiving module 210 may be a pure hardware module, and the pure hardware module includes, but is not limited to, an application specific integrated circuit.

In some embodiments, the information processing apparatus further includes: a storage module, and the storage module is configured to store the SR information.

In some embodiments, the receiving module 210 is further configured to receive a bitmap on the SR resource, where the bitmap indicates the SR information associated with the plurality of SR configurations, the bitmap includes a plurality of bits, and each of the bits indicates whether the UE has generated an SR associated with one of the SR configurations.

In some embodiments, the bitmap has a correspondence relationship with a first-type sequence, and different bit values of the bitmap correspond to different cyclic shifts and/or sequence types of the first-type sequence.

In some embodiments, the receiving module 210 is further configured to send an indication field on the SR resource, where the indication field indicates the SR information, the indication field includes: ┌log₂ N┐ bits, and the N is a number of the SR configurations.

In some embodiments, a bit sequence of ┌log₂ N┐ bits in the indication field indicates whether the UE has generated an SR associated with one or more SR configurations among the N SR configurations;
or,
a bit sequence of ┌log₂ N┐ bits in the indication field indicates that the UE has generated an SR associated with a m-th SR configuration, where the m-th SR configuration is an SR configuration with a highest mapped logical channel priority among X SR configurations, the X SR configurations are SR configurations associated with the SR generated by the UE, the m is a natural number less than the y, and the X is a natural number less than the N.

In some embodiments, the indication field has a correspondence relationship with a second-type sequence, and different bit sequences of the indication field correspond to different cyclic shifts and/or sequence types of the second-type sequence.

In some embodiments, the receiving module, is configured to receive a physical uplink control channel (PUCCH) message on the SR resource, where the PUCCH message includes the SR information associated with the plurality of SR configurations.

In some embodiments, a format of the PUCCH message includes: format 0, format 1, format 2, format 3 or format 4.

In some embodiments, the apparatus further includes:
a sending module, configured to send an SR resource configuration, where an SR resource indicated by the SR resource configuration is associated with a plurality of SR configurations.

In some embodiments, the plurality of SR configurations associated with the SR information carried by the SR resource have the identical first parameter and different second parameters, where the first parameter is used for reporting the SR information of the SR configurations, and the second parameter is at least used to determine a logical channel corresponding to an SR configuration.

In some embodiments, the first parameter includes at least one of:
a parameter of a prohibition timer, used to start the prohibition timer, where receiving the SR information is stopped during a running time of the prohibition timer; or
a maximum number of transmissions, used to indicate a maximum number of repeated transmissions of an SR for one of the SR configurations.

An embodiment of the present disclosure provides a communication device, including:
a memory, configured to store processor-executable instructions;
one or more processors, respectively connected with the memory;
where, the processor is configured to execute the information processing method provided by any of the foregoing technical solutions.

The processor may include various types of storage media that are non-transitory computer storage media capable of continuing to memorize the information stored thereon after the communication device is powered down.

Here, the communication device includes a UE or a network device.

The processor may be connected to the memory via a bus, etc., for reading an executable program stored on the memory, e.g., at least one of the methods as shown in FIG. 2A to 2E or 3A to 3D.

FIG. 6 is a block diagram of a UE 800 according to an embodiment of the present disclosure. For example, the UE 800 may be a mobile phone, a computer, a digital broadcasting user equipment, a messaging device, a game console, a tablet device, a medical device, a fitness device, a personal digital assistant, etc.

Referring to FIG. 6, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls an overall operation of the UE 800, such as operations associated with display, telephone call, data communication, camera operation and recording operation. The processing component 802 may include one or more processors 820 to execute instructions to generate all or part of steps of the above-mentioned method. In addition, the processing component 802 may include one or more modules to facilitate interactions between the processing component 802 and other components. For example, the processing component 802 may include a multimedia module to facilitate interactions between the multimedia component 808 and the processing component 802.

The memory 804 is configured to store various types of data to support operations in the UE 800. Examples of these data include instructions of any application program or method for being operated on the UE 800, contact data, phone book data, messages, pictures, videos, etc. The memory 804 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the UE 800. The power component 806 may include a power management system, one or more power supplies, and other components associated with generating, managing and distributing power for the UE 800.

The multimedia component 808 includes a screen that provides an output interface between the UE 800 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 808 includes a front camera and/or a rear camera. When the UE 800 is in an operation mode, such as a shooting mode or a video mode, the front camera and/or the rear camera can receive external multimedia data. Each front camera and rear camera may be a fixed optical lens system or have focal length and optical zoom capability.

The audio component 810 is configured to output and/or input audio signals. For example, the audio component 810 includes a microphone (MIC) configured to receive external audio signals when the UE 800 is in the operation mode, such as a calling mode, a recording mode and a voice recognition mode. The received audio signal may be further stored in the memory 804 or transmitted via the communication component 816. In some embodiments, the audio component 810 further includes a speaker for outputting audio signals.

The I/O interface 812 provides an interface between the processing component 802 and peripheral interface modules, where the peripheral interface modules may be keyboards, click-wheels, buttons, etc. These buttons may include, but are not limited to: home button, volume button, start button and lock button.

The sensor component 814 includes one or more sensors for providing various aspects of state evaluation for the UE 800. For example, the sensor component 814 can detect an on/off state of the UE 800, a relative positioning of components, for example, the components are the display and the keypad of the UE 800, and the sensor component 814 can further detect a position change of the UE 800 or a component of the UE 800, presence or absence of user contact with the UE 800, orientation or acceleration/deceleration of the UE 800 and a temperature change of the UE 800. The sensor component 814 may include a proximity sensor configured to detect presence of a nearby object without any physical contact. The sensor component 814 may also include an optical sensor, such as a CMOS or CCD image sensor, for use in imaging applications. In some embodiments, the sensor component 814 may further include an acceleration sensor, a gyroscope sensor, a magnetic sensor, a pressure sensor or a temperature sensor.

The communication component 816 is configured to facilitate wired or wireless communication between the UE 800 and other devices. The UE 800 can access a wireless network based on communication standards, such as WiFi, 4G or 5G, or combinations thereof. In an embodiment of the present disclosure, the communication component 816 receives a broadcast signal or broadcast related information from an external broadcast management system via a broadcast channel. In an embodiment of the present disclosure, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the UE 800 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 804 including instructions, where the instructions can be executed by a processor 820 of the UE 800 to generate the above-mentioned delay determination method. For example, the non-transitory computer-readable storage medium may be an ROM, a random access memory (RAM), a CD-ROM, a magnetic tape, a floppy disk, an optical data storage device, etc.

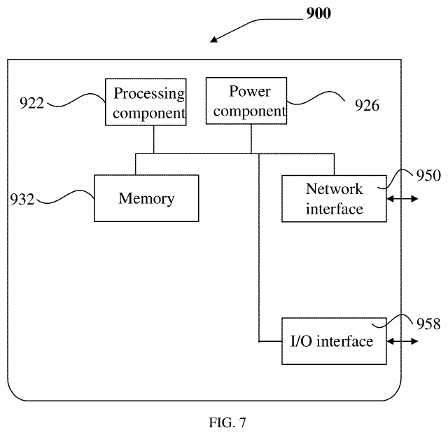

As shown in FIG. 7, an embodiment of the present disclosure shows a structure of a network device. The network device may be a base station. Referring to FIG. 7, the network device 900 includes a processing component 922, which further includes one or more processors, and memory resources represented by a memory 932 for storing instructions that can be executed by the processing component 922, such as application programs. An application program stored in the memory 932 may include one or more modules each corresponding to a set of instructions. In addition, the processing component 922 is configured to execute instructions to perform any of the aforementioned methods applied to the access device, for example, at least one of the methods shown in FIG. 2A to 2E or 3A to 3D.

The network device 900 may further include a power component 926 configured to perform power management of the network device 900, a wired or wireless network interface 950 configured to connect the network device 900 to a network, and an input-output (I/O) interface 958. The network device 900 can operate based on an operating system stored in the memory 932, such as Windows Server™, Mac OS X™, Unix™, Linux™, FreeBSD™ or the like. Other implementations of the embodiments of the present disclosure will easily occur to those skilled in the art after considering the specification and practicing the present disclosure disclosed herein.

The present disclosure is intended to cover any variations, uses or adaptations of the embodiments of the present disclosure, and these variations, uses or adaptations follow general principles of the embodiments of the present disclosure and include common sense or common technical means in the technical field that are not disclosed in the present disclosure. The specification and embodiments are to be regarded as exemplary only, and true scope and spirit of the embodiments of the present disclosure are indicated by the following claims.

It should be understood that the embodiments of the present disclosure are not limited to precise structures described above and shown in the accompanying drawings, and various modifications and changes can be made without departing from its scope. The scope of the embodiments of the present disclosure is limited only by the appended claims.

1. An information processing method, performed by a user equipment (UE) and comprising:
sending, on a scheduling request (SR) resource, SR information associated with a plurality of SR configurations, wherein the SR information indicates whether the UE has generated an SR associated with the SR configurations.

2. The method according to claim 1, wherein the sending, on an SR resource, SR information associated with a plurality of SR configurations comprises:
sending a bitmap on the SR resource, wherein the bitmap indicates the SR information associated with the plurality of SR configurations, the bitmap comprises a plurality of bits, and each of the bits indicates whether the UE has generated an SR associated with one of the SR configurations.

3. The method according to claim 2, wherein the bitmap has a correspondence relationship with a first-type sequence, and different bit values of the bitmap correspond to different cyclic shifts and/or sequence types of the first-type sequence.

4. The method according to claim 1, wherein the sending, on an SR resource, SR information associated with a plurality of SR configurations comprises:
sending an indication field on the SR resource, wherein the indication field indicates the SR information, the indication field comprises ┌log₂ N┐ bits, and the N is a number of the plurality of SR configurations;
wherein a bit sequence of ┌log₂ N┐ bits in the indication field indicates:
whether the UE has generated an SR associated with one or more SR configurations among the N SR configurations; or
that the UE has generated an SR associated with a m-th SR configuration, wherein the m-th SR configuration is an SR configuration with a highest mapped logical channel priority among X SR configurations, the X SR configurations are SR configurations associated with the SR generated by the UE, the m is a natural number less than or equal to the N, and the X is a natural number less than or equal to the N.

5. (canceled)

6. The method according to claim 4, wherein the indication field has a correspondence relationship with a second-type sequence, and different bit sequences of the indication field correspond to different cyclic shifts and/or sequence types of the second-type sequence.

7. The method according to claim 1, wherein the SR information has a correspondence relationship with a third-type sequence, and different kinds of the SR information correspond to different cyclic shifts and/or sequence types of the third-type sequence.

8. The method according to claim 1, wherein the sending, on an SR resource, SR information associated with a plurality of SR configurations comprises:
sending a physical uplink control channel (PUCCH) message on the SR resource, wherein the PUCCH message comprises the SR information associated with the plurality of SR configurations, wherein a format of the PUCCH message comprises: format 0, format 1, format 2, format 3, or format 4.

9. (canceled)

10. The method according to claim 1, further comprising:
receiving an SR resource configuration, wherein the SR resource configuration indicates one or more SR resources, and at least one of the one or more SR resources is associated with the plurality of SR configurations.

11. The method according to claim 1, wherein the plurality of SR configurations associated with the SR information carried by the SR resource have an identical first parameter, wherein the first parameter is used for reporting the SR information of the SR configurations,
wherein the first parameter comprises at least one of:
a parameter of a prohibition timer, used to start the prohibition timer, wherein reporting the SR information is prohibited during a running time of the prohibition timer; or
a maximum number of transmissions, used to indicate a maximum number of repeated transmissions of an SR for one of the SR configurations.

12. (canceled)

13. An information processing method, performed by a network device and comprising:
receiving, on a scheduling request (SR) resource, SR information associated with a plurality of SR configurations, wherein the SR information indicates whether a user equipment (UE) has generated an SR associated with the SR configurations.

14. The method according to claim 13, wherein the receiving, on an SR resource, SR information associated with a plurality of SR configurations comprises:
receiving a bitmap on the SR resource, wherein the bitmap indicates the SR information associated with the plurality of SR configurations, the bitmap comprises a plurality of bits, and each of the bits indicates whether the UE has generated an SR associated with one of the SR configurations,
wherein the bitmap has a correspondence relationship with a first-type sequence, and different bit values of the bitmap correspond to different cyclic shifts and/or sequence types of the first-type sequence.

15. (canceled)

16. The method according to claim 13, wherein the receiving, on an SR resource, SR information associated with a plurality of SR configurations comprises:
receiving an indication field on the SR resource, wherein the indication field indicates the SR information, the indication field comprises: ┌log₂ N┐ bits, and the N is a number of the SR configurations.

17. The method according to claim 16, wherein a bit sequence of ┌log₂ N┐ bits in the indication field indicates:
whether the UE has generated an SR associated with one or more SR configurations among the N SR configurations; or
that the UE has generated an SR associated with a m-th SR configuration, wherein the m-th SR configuration is an SR configuration with a highest mapped logical channel priority among X SR configurations, the X SR configurations are SR configurations associated with the SR generated by the UE, the m is a natural number less than the N, and the X is a natural number less than the N.

18. The method according to claim 17, wherein the indication field has a correspondence relationship with a second-type sequence, and different bit sequences of the indication field correspond to different cyclic shifts and/or sequence types of the second-type sequence.

19. The method according to claim 13, wherein the SR information has a correspondence relationship with a third-type sequence, and different kinds of the SR information correspond to different cyclic shifts and/or sequence types of the third-type sequence.

20. The method according to claim 13, wherein receiving, on an SR resource, SR information associated with a plurality of SR configurations comprises:
receiving a physical uplink control channel (PUCCH) message on the SR resource, wherein the PUCCH message comprises the SR information associated with the plurality of SR configurations.

21. The method according to claim 20, wherein a format of the PUCCH message comprises: format 0, format 1, format 2, format 3 or format 4.

22. The method according to claim 13, further comprising:
sending an SR resource configuration, wherein the SR resource configuration indicates one or more SR resources, and at least one of the one or more SR resources is associated with the plurality of SR configurations.

23. The method according to claim 13, wherein the plurality of SR configurations associated with the SR information carried by the SR resource have an identical first parameter, wherein the first parameter is used for reporting the SR information of the SR configurations,
wherein the first parameter comprises at least one of:
a parameter of a prohibition timer, used to start the prohibition timer, wherein receiving the SR information is stopped during a running time of the prohibition timer; or
a maximum number of transmissions, used to indicate a maximum number of repeated transmissions of an SR for one of the SR configurations.

24.-26. (canceled)

27. A user equipment (UE), comprising:
a processor;
a transceiver; and
a memory storing a program executable by the processor,
wherein the processor is configured to:
send, on a scheduling request (SR) resource, SR information associated with a plurality of SR configurations, wherein the SR information indicates whether the UE has generated an SR associated with the SR configurations.

28. (canceled)
